(19) United States
(12) Patent Application Publication
(10) Pub. No.: US 2016/0053108 A1
(43) Pub. Date: Feb. 25, 2016

(54) HARDENERS FOR COLD-CURING EPOXY SYSTEMS

(71) Applicant: BLUE CUBE IP LLC, Midland, MI (US)

(72) Inventors: Markus Schroetz, Baltringen (DE); Eva-Maria Michalski, Rheinmuenster (DE); Marcus Pfarherr, Baltringen (DE); Michael M. Grasse, Munzingen (DE); Christina Fritsche, Baltringen (DE)

(21) Appl. No.: 14/773,540

(22) PCT Filed: Mar. 10, 2014
(86) PCT No.: PCT/US14/22611

§ 371 Date: Sep. 8, 2015

Related U.S. Application Data
(60) Provisional application No. 61/824,411, filed on May 17, 2013.

(51) Int. Cl. C08L 63/00; C09J 163/00; C09D 163/00

(52) U.S. Cl. CPC C08L 63/00; C09D 163/00; C09J 163/00; C08L 2205/025

(57) ABSTRACT

A process comprising: a) producing a first adduct comprising a reaction product of a difunctional epoxy and Isophrondiamine (IPDA); b) producing a second adduct comprising a reaction product of a difunctional epoxy and m-Xylylenediamine (MXDA) and c) contacting i) the first adduct; ii) the second adduct; iii) an accelerator; and iv) a modifier to form a hardener composition, is disclosed. The hardener composition can be used with an epoxy compound to form a curable composition.

### REFERENCE TO RELATED APPLICATIONS

This application claims benefit of U.S. Provisional Application No. 61/824,411, filed on May 17, 2013.

### BACKGROUND OF THE INVENTION

1. Field of the Invention

The present invention is related to cold curing epoxy systems. Specifically, the present invention is related to hardeners for cold curing epoxy systems.

2. Introduction

Cold curing epoxy systems are suitable for a wide range of industrial applications, such as floorings, mortars, adhesives, coatings, lacquers, and paints. Most of the cold curing epoxy systems contain amine hardeners.

Typically, the amine hardener is produced as follows: a mixture of amines (A1 and A2), along with a solvent and accelerator are homogenized and heated to the appropriate reaction temperature. A difunctional liquid epoxy resin (LER) is then added to form adducts. Three types of adducts are formed by this process: A1-LER-A1, A2-LER-A2, and A1-LER-A2. It is not desirable to have the mixed adduct A1-LER-A2, since it can cause problems with technical performance. Mixed adducts are also generally not supported by most local regulations, such as the United States Toxic Substances Control Act (TSCA) or the Registration, Evaluation, Authorization and Restriction of Chemical Substances (REACH) of the European Union.

One potential solution is to have an adduct containing a first amine diluted with an adduct containing a second amine. However, with high adducted hardeners (hardeners with high loadings of LER), it can be difficult to impossible to adduct only the first or second amine. If a high adducted hardener only contains a small amount of one amine, the equivalent or molar ratio may be too high and it can produce a highly viscous or even a gelled material which is highly undesirable.

Therefore, a process that eliminates the formation of mixed adducts but also forms a product without any of the drawbacks listed above is needed.

### SUMMARY OF THE INVENTION

In a broad embodiment of the present invention, there is disclosed a process comprising, consisting of, or consisting essentially of: a) producing a first adduct comprising a reaction product of a difunctional epoxy and Isophrondiamine (IPDA); b) producing a second adduct comprising a reaction product of a difunctional epoxy and m-Xylylenediamine (MXDA) and c) contacting i) the first adduct; ii) the second adduct;iii) an accelerator; and iv) a modifier to form a hardener composition.

### DETAILED DESCRIPTION OF THE INVENTION

### Adducts

The first adduct comprises a reaction product of a difunctional epoxy and isophorone diamine (IPDA). The second adduct comprises a reaction product of a difunctional epoxy and m-xylylenediamine (MXDA).

Examples of epoxies that can be used include but are not limited to bisphenol A diglycidyl ether and bisphenol F diglycidyl ether.

In an embodiment, the amine component to form i) or ii) is generally used in molar excess compared to the difunctional epoxy or up to a maximum ratio of 1:1 mole, to ensure that the first and second adducts are aminofunctional molecules which also contain an unreacted amine.

In the first adduct, the IPDA component is present in an amount in the range of from 99 weight percent to 1 weight percent and the epoxy component is present in an amount in the range of from 1 weight percent to 50 weight percent, based on the total weight of the composition.

In the second adduct, the MXDA component is present in an amount in the range of from 99 weight percent to 50 weight percent and the epoxy component is present in an amount in the range of from 1 weight percent to 50 weight percent, based on the total weight of the composition.

Generally, one of ordinary skill in the art can determine the amount of the adduct components to use in the hardener formulation. The nature of the amine component used in the first and second adducts and the degree of the reaction with the difunctional epoxy component can strongly affect the viscosity of either adduct. If the first adduct is highly viscous, then less can be used in the hardener formulation. If the first adduct has a low viscosity, then more of the adduct can be used in the overall hardener formulation. If the second adduct is highly viscous, then less can be used in the hardener formulation. If the second adduct has a low viscosity, then more of the adduct can be used in the overall hardener formulation.

In an embodiment, the first adduct is present in the hardener composition in the range of from 1 weight percent to 99 weight percent, based on the total weight of the composition. The first adduct is present in the composition in the range of from 5 weight percent to 80 weight percent in another embodiment, and from 10 weight percent to 50 weight percent in yet another embodiment.

In an embodiment, the second adduct is present in the hardener composition in the range of from 1 weight percent to 99 weight percent, based on the total weight of the composition. The first adduct is present in the composition in the range of from 5 weight percent to 80 weight percent in another embodiment, and from 10 weight percent to 50 weight percent in yet another embodiment.

In an embodiment, the first adduct and second adduct are produced separately. Adduct formation takes place at elevated temperatures from 60 to 120° C. controlling the reaction by addition speed. The addition speed depends mainly on the cooling power of the reactor used. In an embodiment, the temperature is in the range of from 75° C. to 95° C. The reactor is charged with the amine and the difunctional epoxy is added while stirring. After the addition is finished, a post reaction of 20 to 40 minutes is performed. During the post reaction time the reaction between the difunctional epoxy and amine continues to completion, so that no unreacted epoxy remains in the reaction mixture.

The first adduct, second adduct, accelerator, and modifier (if desired) are then admixed in any combination or sub-combination. Since the first adduct and second adduct are added separately to the reaction mixture, no mixed adducts of type A1-LER-A2 are present in the mixture. As a high degree of adduction is desired in order to limit the content of free amine in the hardener, it is not favorable to adduct only amine 1 or amine 2, especially if the amount of one amine is much lower than the other, due to the fact that a) the adduct must be aminic and b) must have a viscosity in a technically manageable range.

### Accelerator

In an embodiment, the first adduct and second adduct are contacted with an accelerator. An accelerator is useful for accelerating the curing speed of the composition with an epoxy resin.

Examples of accelerators include, but are not limited to salicylic acid, calcium nitrate, bisphenol A, bisphenol F, mono—and dihydric phenols like resorcinol and hydroquinone or other carboxylic and/or phenolic group containing components.

The accelerator is generally present in the composition in the range of from 0.1 weight percent to 30 weight percent, based on the total weight of the composition.

### Modifier

In an embodiment, the components above can be contacted with a modifier. The modifier is useful for dilution and may accelerate the curing speed in combination with epoxy resins. The modifier can also enhance surface appearance.

Examples of modifiers include, but are not limited to (methyl) styrenated phenol, diisopropylnaphthalene, polyalkylene glycols, ethers of polyalkylene glycols, benzyl alcohol, and high boiling mono- or polyhydric alcohols.

The modifier is generally present in a range of from 0.1 weight percent to 60 weight percent, based on the total weight of the hardener composition.

Third amine or Amine/Monofunctional Epoxy Adduct

Optionally, the mixture above may contain a third amine or an aminofunctional reaction product of the third amine with a monofunctional epoxy compound. The third amine or its aminofunctional adduct with a monofunctional epoxy can be useful for fine-tuning properties like surface appearance or chemical resistance of the cured coating.

Examples of the third amine include, but are not limited to aliphatic amines, cycloaliphatic amines, araliphatic amines or aromatic amines. Examples of the monofunctional epoxy compound include, but are not limited to epoxidized monohydric alcohols.

### Curable Composition Product

In an embodiment, a curable composition comprises, consists of, of consists essentially of: I) the hardener formed by the above-described process and II) an epoxy resin.

In an embodiment, the epoxy resin is a liquid epoxy resin. Examples of liquid epoxy resins that can be used include, but are not limited to bisphenol-A diglycidyl ethers (BADGE), bisphenol-F diglycidyl ethers (BFDGE), and epoxy novolacs. In another embodiment, the epoxy resin can be a solid bisphenol A epoxy resin.

The curable composition can be optionally diluted with reactive diluents such as for example cresyl glycidyl ether (CGE), p. t.-butylphenyl glycidyl ether (ptBPGE), C12/C14 glycidyl ether, butanediol diglycidyl ether (BDDGE), hexanediol-diglycidyl ether (HDDGE), branched glycidyl ethers such as C13/15 or C 12/14, alcohol glycidyl ether, and glycidyl esters such as Versatic Acid glycidyl esters.

In an embodiment, the hardener composition is present in an amount in the range of from 0.8 amine equivalents to 1.2 amine equivalents and the epoxy resin is present in an amount 0.8 epoxy equivalents to 1.2 epoxy equivalents. In an embodiment, the hardener component and the epoxy resin are mixed according to the hardener equivalent weight (HEW) and epoxide equivalent weight (EEW) to ensure that 1 equivalent of epoxy reacts with 1 equivalent amine hydrogen. The composition is cured at ambient temperature.

These compositions are generally used as primers for concrete and floorings.

### EXAMPLES

### Preparation of IPDA Adduct

1 gram of a mixture of IPDA with D.E.R. 331 (6 moles: 1 mole) was prepared at room temperature and was transferred via droplets into a DSC crucible, heated to 90° C. and the heat flux was measured. After 35 minutes the reaction was considered to be finished.

On a larger scale, the amine was placed in a flask with heating jacket and stirrer and was heated. The liquid epoxy resin (LER) was added from above, the rate of addition was selected to maintain the temperature. If necessary, the flask was cooled by removing the heating jacket. After addition, the post reaction was performed for at least 35 minutes at the reaction temperature.

Preparation of MXDA Adduct 1 gram of a mixture of MXDA with D.E.R. 331 (4 moles: 1 mole) was prepared at room temperature and a droplet transferred into a DSC crucible, heated to 80° C. and the heat flux was measured. After 25 minutes the reaction was considered to be finished.

On a larger scale, the amine was placed in a flask with heating jacket and stirrer and was heated. The LER was then added from above, the rate of addition was to maintain the temperature. If necessary, the flask was cooled by removing the heating jacket. After addition, the post reaction was performed for at least 25 minutes at the reaction temperature.

The hardeners are prepared as follows:

For comparative example A: Benzyl alcohol was charged to a reactor, which was then heated. When the reactor temperature reached 40° C., salicylic acid was added and dissolved. IPD and MXDA were then charged to the reactor and the mixture was heated to 80-90° C. D.E.R. 331 was then added from above under stirring. After 1 hour, the batch was cooled to 50° C. and discharged. In the hardener, adduct types of A1-LER-A1, A2-LER-A2 and A1-LER-A2 were present.

For the comparative example B: Benzyl alcohol was charged to a reactor, which was then heated. When the reactor temperature reached 40° C., IPD and MXDA were charged and the mixture was heated to 80-90° C. D.E.R. 331 was added from above under stirring after 1 hour, the batch was cooled to 50° C. and discharged. In the hardener adduct types of A1-LER-A1, A2-LER-A2 and A1-LER-A2 were present.

For the comparative example C: Benzyl alcohol was charged to a reactor, which was then heated. When the reactor temperature reached 40° C., salicylic acid was added and dissolved. IPD , the IPDA-Adduct and MXDA were charged and the mixture was homogenized for 30 minutes and discharged. In the hardener, adduct types of A1-LER-A1 are present.

For the inventive example 1: Benzyl alcohol was charged to a reactor, which was then heated. When the reactor temperature reached 40° C., MXDA, the MXDA-adduct and the IPD-adduct was charged and the mixture was homogenized for 30 minutes and discharged. In the hardener, adduct types of A1-LER-A1, A2-LER-A2 are present.

The hardeners were mixed with D.E.R.™ 3531, a diluted epoxy resin which is a blend of Bisphenol A epoxy resin and Bisphenol F epoxy resin, with C12/C14 alcohol glycidyl ether as a reactive diluent, at 1 epoxy equivalent to 1 amine equivalent at room temperature to yield a curable composition.

2 mm films were cast after 2 minutes of homogenization of the resin/hardener by hand.

200 μm films were coated on glass, using an applicator frame.

Hardening conditions can be found in the corresponding tables.

TABLE 1
Hardener Ingredients

| | Examples | | | |
|---|---|---|---|---|
| | Comparative | Comparative | Comparative | Inventive |
| | example A | example B | example C (in | example 1 |
| | (in situ) | (blend) | situ) | (blend) |
| Benzyl alcohol | 40 | 40 | 40 | 40 |
| Salicylic acid | 5 | 5 | none | none |
| IPDA | 35 | 11.7 | 30 | 2 |
| LER (D.E.R. | 10 | none | 15 | none |
| 331) | | | | |
| MXDA | 10 | 10 | 15 | 10.5 |
| IPDA-Adduct | none | 33.3 | none | 40 |
| MXDA-Adduct | none | none | none | 7.5 |
| | 100.0 | 100.0 | 100.0 | 100.0 |

All results are measured with D.E.R.™ 3531

TABLE 2
ShoreD Hardness development

| | Examples | | | |
|---|---|---|---|---|
| | Comp Ex A (in | Comp Ex B | Comp Ex C (in | Example 1 |
| | situ) | (blend) | situ) | (blend) |
| After | Climate 23° C./50% rH | | | |
| 16 h | 51 | 48 | 43 | 45 |
| 18 h | 56 | 53 | 53 | 50 |
| 24 h | 63 | 62 | 65 | 60 |
| 48 h | 72 | 71 | 73 | 70 |
| 7 d | 74 | 71 | 77 | 73 |
| After | Climate 13° C./80% rH | | | |
| 16 h | Not measurable | 23 | Not measurable | Not measurable |
| 18 h | 25 | 29 | Not measurable | 24 |
| 24 h | 42 | 42 | 34 | 37 |
| 48 h | 65 | 69 | 63 | 67 |
| 7 d | 76 | 74 | 73 | 72 |

Table 3 shows the hardness development of the 2 mm cast thick layers. All results are measured with D.E.R.™ 3531.

TABLE 3
Pendulum hardness (Koenig)

| | Examples | | | |
|---|---|---|---|---|
| | Comp Ex A (in | Comp Ex B | Comp Ex C (in | Example 1 |
| | situ) | (blend) | situ) | (blend) |
| After | Climate 23° C./50% rH | | | |
| 16 h | 20 | 23 | 27 | 24 |
| 18 h | 29 | 29 | 35 | 33 |
| 24 h | 42 | 45 | 52 | 52 |
| 48 h | 83 | 95 | 106 | 109 |
| 7 d | 146 | 147 | 143 | 134 |
| | Climate 13° C./80% rh | | | |
| 16 h | Not measurable | Not measurable | Not measurable | Not measurable |
| 18 h | 8 | 6 | 5 | 6 |
| 24 h | 12 | 11 | 8 | 9 |
| 48 h | 41 | 43 | 29 | 35 |
| 7 d | 109 | 125 | 121 | 107 |

TABLE 4
Early water spot resistance

| | Examples | | | |
|---|---|---|---|---|
| | Comp Ex A | Comp Ex B | Comp Ex C | Example 1 |
| | (insitu) | (blend) | (insitu) | (blend) |
| After | Climate 23° C./50% rH | | | |
| 16 h | Very good | Very good | Very good | Very good |
| | Climate 13° C./80% rH | | | |
| 16 h | Good | Good | fair | fair |

TABLE 5
Tensile test

| | Comp Ex A | Comp Ex B | Comp Ex C | Example 1 |
|---|---|---|---|---|
| | (in situ) | (blend) | (in situ) | (blend) |
| | 7 d at Climate 23° C./50% rH | | | |
| Tensile strength | 32 N/mm² | 31 N/mm² | 39 N/mm² | 33 N/mm² |
| Elongation | 2.0% | 1.8% | 3.6% | 2.0% |

The test methods are listed in Table 6, below.

TABLE 6
Test methods

| Test | Dimension | Standard | Specimen |
|---|---|---|---|
| Hardness | n.a. | DIN 53505 | d = 6 mm |
| ShoreD | | | |
| Hardness (Pendulum | s | DIN 53157 | Film on glass plate |
| Koenig) | | | (100-200 μm) |
| Tensile strength | N/mm² | EN ISO 527-2 | Type 1B |
| Elongation | % | EN ISO 527-2 | Type 1B |

The water drop test was performed as follows: a water drop is placed on the not fully cured surface, the water evaporates, leaving white carbamates on the surface. If not, the hardener is insensitive to the water drop, which is desired.

1. A process comprising:
a) producing a first adduct comprising a reaction product of a difunctional epoxy and Isophrondiamine (IPDA);
b) producing a second adduct comprising a reaction product of a difunctional epoxy and m-Xylylenediamine (MXDA) and
c) contacting
i) the first adduct;
ii) the second adduct;
iii) an accelerator; and
iv) a modifier
to form a hardener composition.

2. A process in accordance with claim 1 wherein said difunctional epoxy is selected from the group consisting of bisphenol A diglycidyl ether and bisphenol F diglycidyl ether.

3. A process in accordance with claim 1 wherein said modifier is selected from the group consisting of benzyl alcohol, (methyl) styrenated phenol and diisopropylnaphthalene.

4. A process in accordance with claim 1 wherein said accelerator is selected from the group consisting of salicylic acid, calcium nitrate, mono phenols, and dihydric phenols.

5. A process in accordance with claim 1 wherein the difunctional epoxy is present in the first adduct in an amount in the range of from 1 weight percent to 35 weight percent and said IPDA is present in the first adduct in an amount in the range of from 99 weight percent to 65 weight percent, based on the total weight of said first adduct.

6. A process in accordance with claim 1 wherein the difunctional epoxy is present in the second adduct in an amount in the range of from 1 weight percent to 45 weight percent and said MXDA is present in the second adduct in an amount in the range of from 99 weight percent to 55 weight percent, based on the total weight of said first adduct.

7. A process in accordance with claim 1 wherein the first adduct is present in the hardener composition in an amount in the range of from 1 weight percent to 99 weight percent, the second adduct is present in an amount in the range of from 1 weight percent to 99 weight percent, the modifier is present in an amount in the range of from 0.1 weight percent to 60 weight percent, and the accelerator is present in an amount in the range of from 0.1 weight percent to 40 weight percent, based on the total weight of the hardener composition.

8. A process in accordance with claim 1 wherein a third amine or an aminofunctional reaction product of the third amine with a monofunctional epoxy compound is contacted with said first adduct, said second adduct, and said accelerator in step c).

9. A process in accordance with claim 8 wherein said third amine is selected from the group consisting of aliphatic amines, cycloaliphatic amines, araliphatic amines and aromatic amines, and wherein the monofuctional epoxy compound is an epoxidized monohydric alcohol.

10. The hardener composition produced by the process of claim 1.

11. A curable composition comprising:
I) the hardener composition produced by the process of claim 1; and
II) an epoxy resin selected from the group consisting of liquid bisphenol-A diglycidyl ethers, liquid bisphenol-F diglycidyl ethers, liquid epoxy novolacs, solid bisphenol-A, and combinations thereof.

12. A curable composition in accordance with claim 11 wherein the hardener composition is present in an amount in the range of from 0.8 amine equivalents to 1.2 amine equivalents and the epoxy resin is present in an amount 0.8 epoxy equivalents to 1.2 epoxy equivalents.

13. A product prepared from the curable composition of claim 11 selected from the group consisting of a primer, a coating, a lacquer, a paint, and adhesive.
